(19) United States
(12) Patent Application Publication
(10) Pub. No.: US 2023/0409392 A1
(43) Pub. Date: Dec. 21, 2023

(54) BALANCED THROUGHPUT OF REPLICATED PARTITIONS IN PRESENCE OF INOPERABLE COMPUTATIONAL UNITS

(71) Applicant: Advanced Micro Devices, Inc., Santa Clara, CA (US)

(72) Inventors: Ashish Jain, Austin, TX (US); Sriram Sundaram, Austin, TX (US); Christopher Allan Poirier, Santa Clara, CA (US); Samuel D. Naffziger, Fort Collins, CO (US)

(21) Appl. No.: 17/844,558

(22) Filed: Jun. 20, 2022

(51) Int. Cl. G06F 9/48; G06F 1/26

(52) U.S. Cl. CPC G06F 9/4893; G06F 1/26

(57) ABSTRACT

An apparatus and method for efficiently managing balanced performance among replicated partitions of an integrated circuit despite loss of functionality due to manufacturing defects. A processing unit includes at least two replicated partitions, each assigned to operation parameters of a respective power domain. The partitions include multiple compute units. The compute units include multiple lanes of execution. Due to a variety of types of manufacturing defects, one or more of the partitions of the processing unit has less than a predetermined number of operational compute units. To balance the throughput of the multiple partitions, a power manager generates both static and dynamic scaling factors based on at least the corresponding number of operational compute units. Using these scaling factors, the power manager adjusts the operation parameters of power domains for the partitions relative to one another.

### BACKGROUND

### Description of the Relevant Art

Both planar transistors and non-planar transistors are fabricated for use in integrated circuits within semiconductor chips. A variety of choices exist for placing processing circuitry in system packaging to integrate the multiple types of integrated circuits. Some examples are a system-on-a-chip (SOC), multi-chip modules (MCMs) and a system-in-package (SiP). Mobile devices, desktop systems and servers use these packages. Regardless of the choice for system packaging, during assembly of semiconductor chips, one or more semiconductor dies (or dies) are placed onto a single substrate or onto a package, and these die are susceptible to an electrostatic discharge event. The electrostatic discharge event provides an inadvertent charge capable of causing a current density to flow through metal wires and transistors (devices) that surpass safe thresholds. Therefore, one or more processing units and other functional blocks on a die can fail, which reduces manufacturing yield.

Prior to packaging and during the semiconductor manufacturing process steps for the die, it is possible that one or more processing units and other functional blocks on a die can also fail. These failures result from manufacturing defects that inadvertently cause open circuits, stuck-at faults, and so forth. During testing of the dies and during later testing of packages, any defects are found. In some cases, the defects occur in a functional block that is replicated in a partition of a processing unit. Although the particular functional block is no longer operational, and the overall throughput of the processing unit is reduced, the partition in the processing unit remains operational.

With the use of fuse arrays and fuse read-only memory (ROM), access can be restricted on the die to particular functional blocks that lack defects within the partition. The semiconductor die is still used, but the resulting package is placed in a reduced performance category or bin. However, for dies that use a highly parallel data microarchitecture, a partition using all of its replicated functional blocks completes its tasks prior to another partition using a smaller number of replicated functional blocks. There is an imbalance of throughput among the partitions, which further reduces performance. In some cases, although still functional, the reduced performance packages are unacceptable due to the high demand in the market for running certain applications at a relatively high minimum performance level.

In view of the above, efficient methods and apparatuses for managing balanced performance among replicated partitions of an integrated circuit despite loss of functionality due to manufacturing defects are desired.

### BRIEF DESCRIPTION OF THE DRAWINGS

FIG. 1 is a generalized block diagram of an apparatus that manages balanced performance among replicated partitions of an integrated circuit despite loss of functionality due to manufacturing defects.

FIG. 2 is a generalized block diagram of a method for managing balanced performance among replicated partitions of an integrated circuit despite loss of functionality due to manufacturing defects.

FIG. 3 is a generalized block diagram of a power manager that manages balanced performance among replicated partitions of an integrated circuit despite loss of functionality due to manufacturing defects.

FIG. 4 is a generalized block diagram of a method for managing balanced performance among replicated partitions of an integrated circuit despite loss of functionality due to manufacturing defects.

FIG. 5 is a generalized block diagram of a computing system.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods efficiently managing balanced performance among replicated partitions of an integrated circuit despite loss of functionality due to manufacturing defects are contemplated. In some implementations, a processing unit includes at least two replicated partitions. As used herein, the term “replicated” is used to refer to an identical instantiation of hardware, such as circuitry, of a particular functional block, a particular type of unit, or another particular type of circuit. For example, “replicated partitions” refer to two or more partitions with each partition being an identical instantiation of a particular type of partition. In an implementation, each of the partitions is a shader engine of a graphics processing unit (GPU). Similarly, “replicated computational units” refer to two or more computational units (or compute units) with each computational unit being an instantiation of a particular type of computational unit. In an implementation, the particular type of computational unit includes multiple lanes of execution that supports a parallel data microarchitecture for processing workloads. Therefore, in an implementation, each of the replicated (instantiated) partitions is a shader engine of a GPU, and each of the shader engines includes multiple replicated (instantiated) compute units.

In various implementations, a processing unit includes at least two replicated (instantiated) partitions, each assigned to operating parameters of a respective power domain. Each of the power domains includes operating parameters such as at least an operating power supply voltage and an operating clock frequency. Each of the power domains also includes control signals for enabling and disabling connections to clock generating circuitry and a power supply reference. Therefore, the at least two replicated partitions do not share the same connections to the same clock generating circuitry and the power supply reference.

Due to a variety of types of manufacturing defects, one or more of the partitions of the processing unit has less than a predetermined number of operational compute units. As used herein, an operational compute unit is also referred to as a functional compute unit. An operational compute unit (a functional compute unit) is capable of processing tasks successfully due to no manufacturing defects. In one example, a processing unit includes four partitions, each with eight compute units. However, due to manufacturing defects, one of the four partitions has seven operational compute units, rather than the predetermined number of eight operational compute units. To balance the throughput of the multiple partitions, a power manager generates a corresponding static scaling factor for each of the multiple partitions relative to one another.

The power manager generates the static scaling factors for each of the multiple replicated partitions based on the corresponding number of operational compute units. The power manager generates the static scaling factors in a manner to balance throughput of the multiple replicated partitions with each partition using a respective power domain. In other words, for a partition of the multiple partitions, the power manager uses a corresponding static scaling factor to select individual operating parameters for the partition. A difference in throughput between any two partitions is less than a threshold. Using at least the static scaling factors, a first partition with 6 of 8 functioning compute units achieves nearly a same throughput as a second partition with 8 of 8 functioning compute units. The difference in throughput between the first partition and the second partition is less than a throughput threshold. Therefore, the difference between completion times of tasks for the first partition and the second partition is less than a time threshold. The static scaling factor for the first partition with 6 of 8 functioning compute units causes the power manager to select operating parameters of a first power domain that provide higher transistor switching speeds than operating parameters of a second power domain used by the second partition with 8 of 8 functioning compute units.

When tasks of a workload are executed by multiple replicated partitions in a lockstep format, and one of the partitions completes significantly later than other partitions, the overall throughput of the processing unit decreases. When tasks of a workload use checkpoints to synchronize execution across the multiple replicated partitions, and one of the partitions completes significantly later than other partitions, the overall throughput of the processing unit decreases. For example, when the first partition has 7 of 8 functioning compute units, rather than 8 of 8 functioning compute units, and each partition uses a same power domain, the first partition completes later than other partitions with 8 of 8 functioning compute units. Therefore, the overall throughput of the processing unit decreases. However, when the first partition uses operating parameters of a separate power domain as described earlier, the reliance on lockstep execution or a synchronizing checkpoint does not reduce performance of the processing unit, since the first partition has a same or nearly same completion time. The difference between completion times of tasks for the first partition and other partitions is less than a time threshold. In addition, the power manager is able to dynamically adjust the operating parameters of the separate power domains at the granularity of a partition, rather than at the granularity of the entire processing unit. This dynamic adjustment is based on performance metrics monitored during the processing of a workload. For example, the power manager receives the performance metrics from performance counters distributed across the compute units. Further details of efficiently managing balanced performance among replicated partitions of an integrated circuit despite loss of functionality due to manufacturing defects are provided in the following discussion.

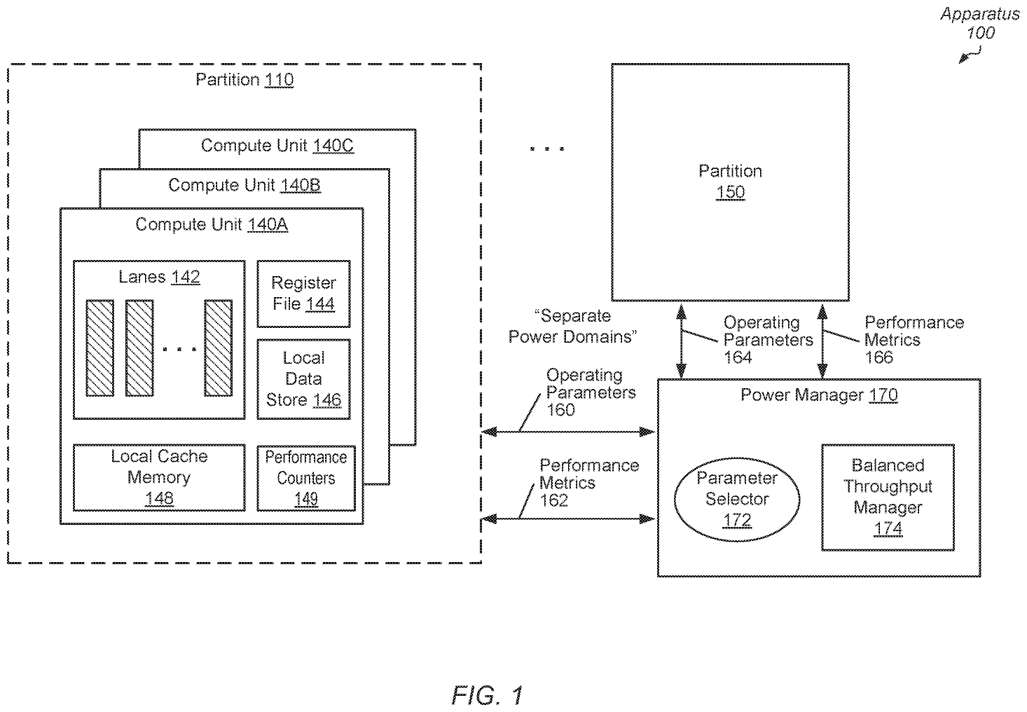

Referring to FIG. 1, a generalized block diagram is shown of an apparatus 100 that manages balanced performance among replicated partitions of an integrated circuit despite loss of functionality due to manufacturing defects. In the illustrated implementation, the apparatus 100 includes the power manager 170 and at least two partitions, such as partition 110 and partition 150, each assigned to a respective power domain by the power manager 170. Each of the power domains includes at least operating parameters such as at least an operating power supply voltage and an operating clock frequency. Each of the power domains also includes control signals for enabling and disabling connections to clock generating circuitry and a power supply reference. Although only two partitions 110 and 150 are shown, other numbers of partitions used by apparatus 100 are possible and contemplated and the number is based on design requirements. Other components of the apparatus 100 are not shown for ease of illustration. For example, a memory controller, one or more input/output (I/O) interface units, interrupt controllers, one or more phased locked loops (PLLs) or other clock generating circuitry, one or more levels of a cache memory subsystem, and a variety of other functional blocks are not shown although they can be used by the apparatus 100.

In some implementations, the functionality of the apparatus 100 is included as components on a single die such as a single integrated circuit. In an implementation, the functionality of the apparatus 100 is included as one die of multiple dies on a system-on-a-chip (SOC). In various implementations, the apparatus 100 is used in a desktop, a portable computer, a mobile device, a server, a peripheral device, or other. The apparatus 100 is capable of communicating with an external general-purpose central processing unit (CPU) that includes circuitry for executing instructions according to a predefined general-purpose instruction set architecture (ISA). The apparatus 100 is also capable of communicating with a variety of other external circuitry such as one or more of a digital signal processor (DSP), a display controller, a variety of application specific integrated circuits (ASICs), a multimedia engine, and so forth.

The power manager 170 decreases (or increases) power consumption if apparatus 100 is operating above (below) a threshold limit. In some implementations, power manager 170 selects a respective power management state for each of the partitions 110 and 150. As used herein, a “power management state” is one of multiple “P-states,” or one of multiple power-performance states that include a set of operational parameters such as an operational clock frequency and an operational power supply voltage. In various implementations, the apparatus 100 uses a parallel data micro-architecture that provides high instruction throughput for a computationally intensive task. In one implementation, the apparatus 100 uses one or more processor cores with a relatively wide single instruction multiple data (SIMD) micro-architecture to achieve high throughput in highly data parallel applications. Each object is processed independently of other objects, but the same sequence of operations is used.

In one implementation, the apparatus 100 is a graphics processing unit (GPU). Modern GPUs are efficient for data parallel computing found within loops of applications, such as in applications for manipulating and displaying computer graphics, molecular dynamics simulations, finance computations, and so forth. The highly parallel structure of GPUs makes them more effective than general-purpose central processing units (CPUs) for a range of complex algorithms. In various implementations, the partition 150 includes the same components as the partition 110, since the partitions 110 and 150 are replicated partitions within the apparatus 100. In an implementation, each of the partitions 110 and 150 is a shader engine of a GPU, and each of the shader engines includes the multiple compute units 140A-140C for processing data parallel applications such as graphics shader tasks.

Each of the compute units 140A-140C includes multiple lanes 142. Each lane is also referred to as a SIMD unit or a SIMD lane. In some implementations, the lanes 142 operate in lockstep. In other implementations, the processing of tasks by the lanes 142 uses synchronizing checkpoints. In various implementations, the data flow within each of the lanes 142 is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration. Each of the computation units within a given row across the lanes 142 is the same computation unit. Each of these computation units operates on a same instruction, but different data associated with a different thread.

As shown, each of the compute units 140A-140C also includes a respective register file 144, a local data store 146 and a local cache memory 148. In some implementations, the local data store 146 is shared among the lanes 142 within each of the compute units 140A-140C. In other implementations, a local data store is shared among the compute units 140A-140C. Therefore, it is possible for one or more of lanes 142 within the compute unit 140A to share result data with one or more lanes 142 within the compute unit 140B based on an operating mode. The high parallelism offered by the hardware of the compute units 140A-140C is used for simultaneously rendering multiple pixels, but it is also capable of simultaneously processing the multiple data elements of the scientific, medical, finance, encryption/decryption and other computations. For example, the partition 110 is used for real-time data processing such as rendering multiple pixels, image blending, pixel shading, vertex shading, and geometry shading. Circuitry of a controller (not shown) receives tasks via a memory controller (not shown). In some implementations, the controller is a command processor of a GPU, and the task is a sequence of commands (instructions) of a function call of an application.

Partition 110 receives operating parameters 160 of a first power domain from power manager 170, and the compute units 140A-140C process tasks using the operational parameters 160. The partition 150 receives operating parameters 164 of a second power domain from power manager 170. It is possible and contemplated that the first power domain and the second power domain are different power domains. Therefore, the power manager 170 is able to dynamically adjust the power domains at the granularity of a partition, such as partitions 110 and 150, rather than at the granularity of the entire apparatus 100. In some implementations, the power manager 170 is an integrated controller as shown, whereas, in other implementations, the power manager 170 is an external unit.

Due to a variety of types of manufacturing defects, one or more of the partitions 110 and 150 has less than a predetermined number of operational compute units such as compute units 140A-140C. In one example, each of the partitions 110 and 150 includes eight compute units. However, due to manufacturing defects, the partition 110 has seven operational compute units, rather than the predetermined number of eight operational compute units. To balance the throughput of the partitions 110 and 150, the power manager 170 generates a corresponding static scaling factor for each of the multiple partitions relative to one another.

The power manager 170 generates the static scaling factors for each of the partitions 110 and 150 based on the corresponding number of operational compute units. For the partition 110 that has seven operational compute units of eight compute units 140A-140C, the power manager 170 generates a static scaling factor for the partition 110 that indicates the partition 110 uses a set of operating parameters of a power domain that provide higher transistor switching speeds than another set of operating parameters of another power domain used by the partition 150 with eight operational compute units of eight compute units 140A-140C. Therefore, the difference between completion times of the partition 110 and the partition 150 is reduced, especially when compared to a case where each of the partition 110 and the partition 150 uses the same set of operating parameters of a same power domain. Despite the partition 110 having a smaller number of operational compute units of compute units 140A-140C than the partition 150, when the partition 110 uses operating parameters of a power domain based on the static scaling factors, the reliance on lockstep execution or a synchronizing checkpoint does not reduce performance of the apparatus 100. For example, the partitions 110 and 150 have a same or nearly same completion time. The difference between completion times of tasks for the partitions 110 and 150 is less than a time threshold.

In addition, the power manager 170 is able to dynamically adjust the power domains of the partitions 110 and 150 based on the corresponding number of operational compute units and the performance metrics 162 and 166 monitored during the processing of a workload. For example, the power manager 170 receives the performance metrics 162 and 166 from performance counters, such as performance counters 149, distributed across the compute units 140A-140C and other components (not shown) of the partitions 110 and 150. In some implementations, the collected data includes predetermined sampled signals. The switching of the sampled signals indicates an amount of switched capacitance. Examples of the selected signals to sample include clock gater enable signals, bus driver enable signals, mismatches in content-addressable memories (CAM), CAM word-line (WL) drivers, and so forth. The collected data can also include data that indicates the performance or throughput of each of the partitions 110 and 150 such as a number of retired instructions, a number of cache accesses, monitored latencies of cache accesses, a number of cache hits, a count of issued instructions or issued threads, and so forth.

In an implementation, the power manager 170 collects data to characterize power consumption and throughput of the partitions 110 and 150 during particular sample intervals. When one or more of the estimated power consumption and estimated throughput of the partitions 110 and 150 changes significantly, the power manager 170 updates the operating parameters 160 and 164 of the separate power domains of the partitions 110 and 150. The operating parameters 160 and 164 can also be referred to as the sets of operating parameters 160 and 164. The updated values of the operating parameters 160 and 164 cause the partitions 110 and 150 to achieve nearly a same throughput. The difference in throughput between the partitions 110 and 150 is less than a throughput threshold. Therefore, the difference between completion times of tasks for the partitions 110 and 150 is less than a time threshold.

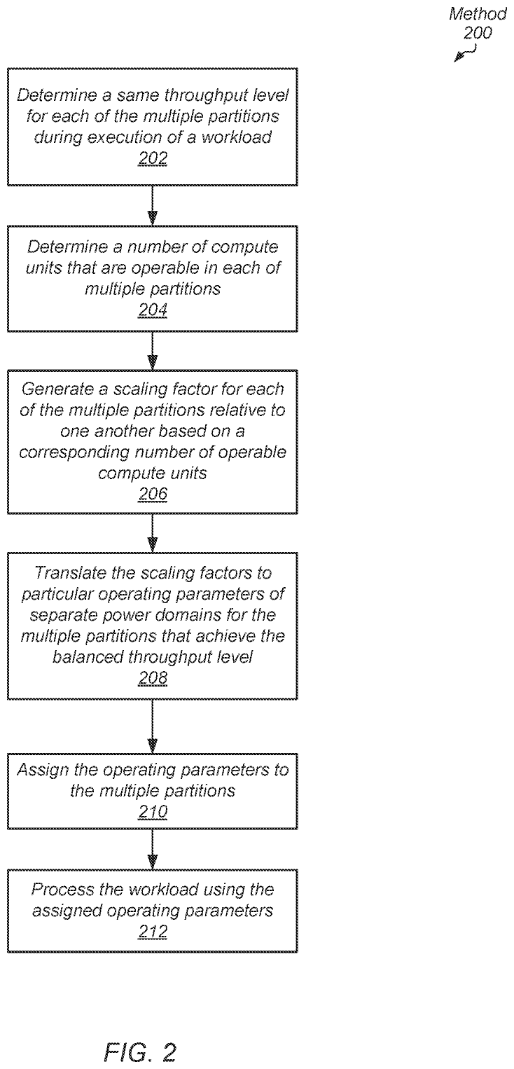

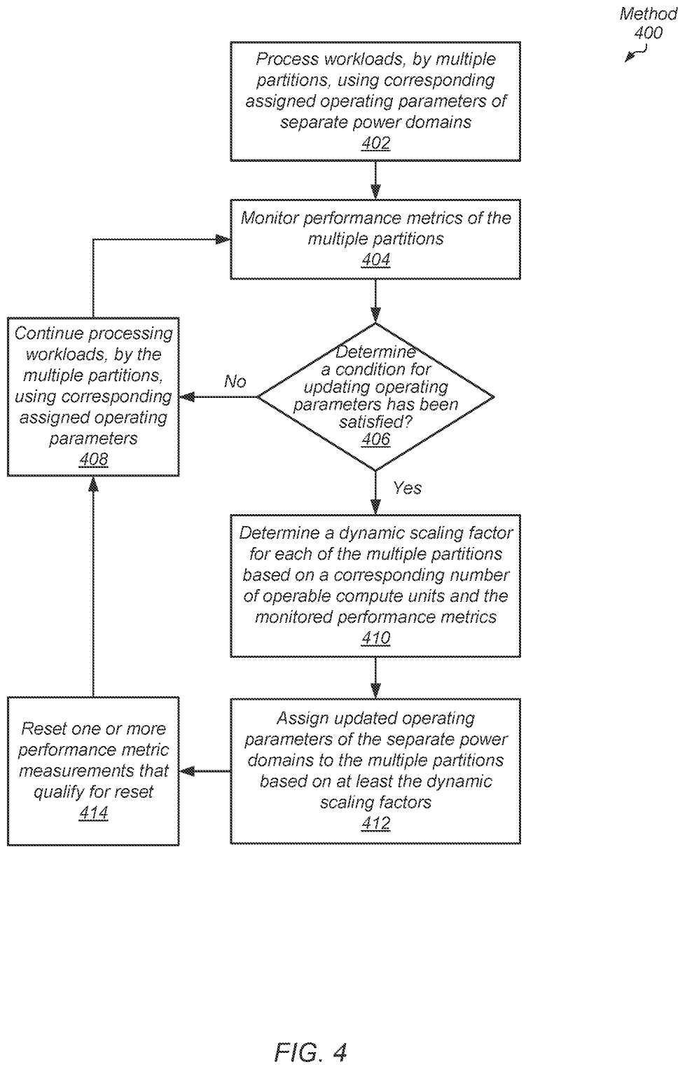

Referring to FIG. 2, a generalized block diagram is shown of a method 200 for efficiently managing balanced performance among replicated partitions of an integrated circuit despite loss of functionality due to manufacturing defects. For purposes of discussion, the steps in this implementation (as well as in FIG. 4) are shown in sequential order. However, in other implementations some steps occur in a different order than shown, some steps are performed concurrently, some steps are combined with other steps, and some steps are absent.

A parallel data processing unit includes at least two partitions, each assigned to a respective power domain. Each of the power domains includes operating parameters such as at least an operating power supply voltage and an operating clock frequency. In some implementations, circuitry of a first partition includes multiple compute units, each with multiple lanes of execution. Hardware, such as circuitry, of a power manager of the parallel data processing unit determines a same throughput level to be expected for each of the multiple partitions during execution of a workload (block 202). The power manager determines a number of compute units that are operable in each of multiple partitions (block 204). As used herein, a compute unit is considered “operable” when the compute unit is able to process tasks. An “operable” compute unit is also referred to as an “operational” compute unit or a “functional” compute unit. In contrast, an “inoperable” compute unit, which is also referred to as a “non-functional” compute unit, is unable to process tasks. For example, the inoperable compute unit has one or more manufacturing defects that prevent it from processing tasks. In an implementation, a fuse array or a fuse ROM is accessed to determine the number of compute units that are operable in each of multiple partitions by identifying which compute units are inoperable compute units.

The power manager generates a static scaling factor for each of the multiple partitions relative to one another based on a corresponding number of operable compute units (block 206). The power manager translates the scaling factors to particular operating parameters of separate power domains for the multiple partitions that achieve the balanced throughput level (block 208). The power manager assigns the operating parameters to the multiple partitions (block 210). The parallel data processing unit processes the workload using the assigned operating parameters (block 212).

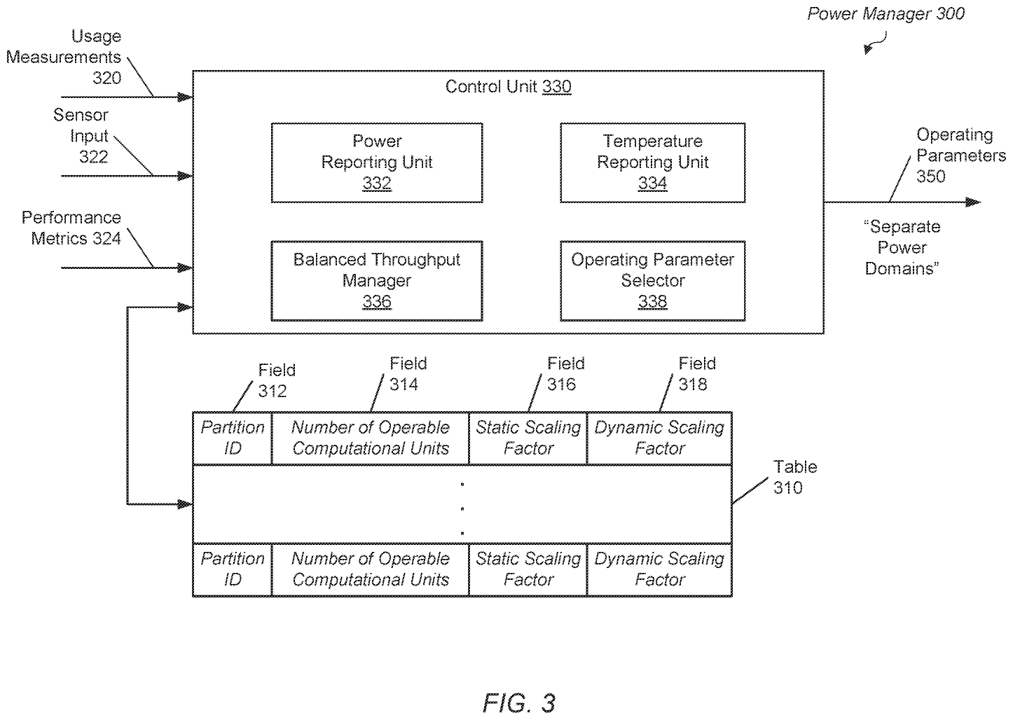

Referring to FIG. 3, a generalized block diagram is shown of a power manager 300 that manages balanced performance among replicated partitions of an integrated circuit despite loss of functionality due to manufacturing defects. As shown, the power manager 300 includes the table 310 and the control unit 330. The control unit 330 includes multiple components 332-338 that are used to generate the operating parameters 350 of multiple power domains, which are sent to multiple replicated partitions. The table 310 includes multiple table entries (or entries), each storing information in multiple fields such as at least fields 312-318.

The table 310 is implemented with one of flip-flop circuits, a random access memory (RAM), a content addressable memory (CAM), or other. Although particular information is shown as being stored in the fields 312-318 and in a particular contiguous order, in other implementations, a different order is used and a different number and type of information is stored. As shown, field 312 stores a partition identifier (ID) that specifies a particular partition of multiple partitions used in a parallel data processing unit. In an implementation, the partition is a shader engine of multiple shader engines of a GPU. The field 314 stores a number of computational units in the identified partition. In an implementation, this information is found in a fuse read only memory (ROM) that is set after manufacturing and testing of a semiconductor package.

The field 316 stores a static scaling factor for the identified partition. The static scaling factor is set based on the corresponding numbers of operational compute units among the multiple partitions. Therefore, the value of the static scaling factor is a relational value. In various implementations, this value is set during or shortly after a bootup operation, and does not change from this value. The field 318 stores a dynamic scaling factor for the identified partition. This value is based on both the corresponding numbers of operational compute units among the multiple partitions and measured performance metrics. This dynamic scaling factor changes over time. For example, the dynamic scaling factor is updated based on one or more of determining a particular time interval has elapsed, determining a new workload is assigned for execution, determining, by the power manager, that the throughput level has changed by more than a threshold amount, or other. In some implementations, a corresponding weight value is associated with each of the static scaling factor and the dynamic scaling factor. In an implementation, each of the multiple replicated partitions has its own pair of weight values. It is possible and contemplated that these weight values change over time, and which one of the static scaling factor and the dynamic scaling factor more greatly affects the selection of operating parameters also changes over time.

The control unit 330 receives usage measurements 320, which represent at least activity level measurements or data from multiple partitions. Examples are sampled signals as described earlier. The control unit 330 receives sensor input 322, which represent measured temperature values from analog or digital thermal sensors placed throughout the die. The control unit 330 receives performance metrics 324, which represent values read from performance counters placed throughout the multiple partitions. The control unit 330 also receives data from the table 310 as well as the control unit 330 is able to update information stored in the table 310.

The power reporting unit 332 calculates a power value from the usage measurements 320. The power reporting unit 332 also calculates a leakage power value to include in a total power value. The leakage power value is dependent on a calculated temperature. In some implementations, the power reporting unit 332 associates a total number of power credits for the parallel data processing unit to a thermal design power (TDP) value for the processing unit. The power reporting unit 332 allocates a separate given number of power credits to each one of the partitions of the parallel data processing unit. A sum of the associated power credits equals the total number of power credits for die 202. The power reporting unit 332 adjusts the number of power credits for each one of the external partitions over time.

The calculated temperature is determined by the temperature reporting unit 334 and utilizes a worst-case ambient temperature value. In an implementation, when the sensor-measured temperature is significantly different from the calculated temperature, the calculated power value does not change. The balanced throughput manager 336 (or manager 336) has the functionality of the balanced throughput manager 174 (of FIG. 1). For example, the manager 336 determines the dynamic scaling factors that are stored in field 318 of table 310 for the multiple partitions. The manager 336 calculates these dynamic scaling factors based on the corresponding number of operational compute units and the performance metrics 324. The manager 336 determines when a performance bottleneck occurs in any of the multiple partitions during the execution of a workload, and recalculates the dynamic scaling factors to be used by the operation parameter selector 338 to generate new power domains for the multiple partitions.

The operating parameter selector 338 receives temperature related values from the temperature reporting unit 334, a calculated power value and both the current number of power credits and an updated number of power credits for each partition from the power reporting unit 332, and updated dynamic scaling factors from the manager 336. Based on these inputs, the operating parameter selector 338 generates updated operating parameters of the separate power domains for the multiple partitions. The updated operating parameters include the operating parameters 350. Although the operating parameter selector 338 receives a variety of input values, the performance metrics 324, the predetermined static scaling factors stored in field 314, and the updated dynamic scaling factors from the manager 336 are the values that adjust the operating parameters 350 to cause partition to have a nearly equivalent throughput.

Referring to FIG. 4, a generalized block diagram is shown of a method 400 for efficiently managing balanced performance among replicated partitions of an integrated circuit despite loss of functionality due to manufacturing defects. Multiple partitions of a parallel data processing unit processes workloads using corresponding assigned operating parameters of separate power domains (block 402). In an implementation, each of the partitions is a shader engine of a graphics processing unit (GPU), and each of the shader engines includes multiple compute units. Hardware, such as circuitry, of a power manager of the parallel data processing unit monitors performance metrics of the multiple partitions (block 404). For example, when a particular sampling interval has elapsed, the values stored in performance counters located across the multiple partitions are read and reported to the power manager.

If the power manager determines a condition for updating operating parameters of the separate power domains has not been satisfied (“no” branch of the conditional block 406), then the multiple partitions of the parallel data processing unit continue processing workloads using corresponding assigned operating parameters of the separate power domains (block 408). In some implementations, the condition for updating power domains includes the power manager determining one or more of a particular time interval has elapsed, and the power manager determining that the throughput level has changed by more than a threshold amount.

If the power manager determines a condition for updating operating parameters of the separate power domains has been satisfied (“yes” branch of the conditional block 406), then the power manager determines a dynamic scaling factor for each of the multiple partitions based on a corresponding number of operable compute units and the monitored performance metrics (block 410). Based on at least the dynamic scaling factors, the power manager assigns updated operating parameters of the separate power domains to the multiple partitions (block 412). In some implementations, when updating the operating parameters of the separate power domains, the power manager additionally uses the static scaling factors and weight values corresponding to both the static scaling factors and the dynamic scaling factors. The power manager resets one or more performance metric measurements that qualify for reset (block 414).

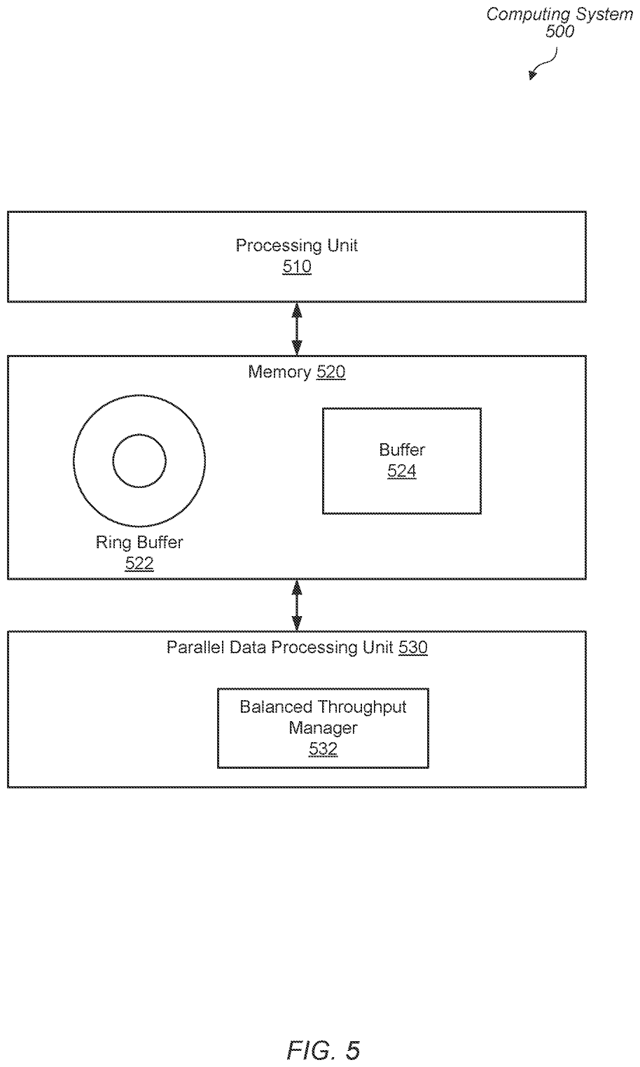

Turning now to FIG. 5, one implementation of a computing system 500 is shown. As shown, the computing system 500 includes a processing unit 510, a memory 520 and a parallel data processing unit 530. In some implementations, the functionality of the computing system 500 is included as components on a single die, such as a single integrated circuit. In other implementations, the functionality of the computing system 500 is included as multiple dies on a system-on-a-chip (SOC). In various implementations, the computing system 500 is used in a desktop, a portable computer, a mobile device, a server, a peripheral device, or other.

The circuitry of the processing unit 510 processes instructions of a predetermined algorithm. The processing includes fetching instructions and data, decoding instructions, executing instructions and storing results. In one implementation, the processing unit 510 uses one or more processor cores with circuitry for executing instructions according to a predefined general-purpose instruction set. In various implementations, the processing unit 510 is a central processing unit (CPU). The parallel data processing unit 530 includes the circuitry and the functionality of the apparatus 100 (of FIG. 1).

The balanced throughput manager 532 (or manager 532) has the functionality of the balanced throughput manager 174 (of FIG. 1) and the balanced throughput manager 336 (of FIG. 3). For example, the manager 532 determines the dynamic scaling factors that used to dynamically update the power domains of the multiple partitions of the parallel data processing unit 530. The manager 532 calculates these dynamic scaling factors based on the corresponding number of operational compute units of the multiple partitions and performance metrics monitored over time during the processing of one or more workloads. The manager 532 determines when a performance bottleneck occurs in any of the multiple partitions during the execution of a workload, and recalculates the dynamic scaling factors to be used to generate new power domains for the multiple partitions.

In various implementations, threads are scheduled on one of the processing unit 510 and the parallel data processing unit 530 in a manner that each thread has the highest instruction throughput based at least in part on the runtime hardware resources of the processing unit 510 and the parallel data processing unit 530. In some implementations, some threads are associated with general-purpose algorithms, which are scheduled on the processing unit 510, while other threads are associated with parallel data computationally intensive algorithms such as video graphics rendering algorithms, which are scheduled on the parallel data processing unit 530. The applications that use these algorithms have copies stored on the memory 520.

Some threads, which are not video graphics rendering algorithms, still exhibit parallel data and intensive throughput. These threads have instructions which are capable of operating simultaneously with a relatively high number of different data elements. Examples of these threads are threads for scientific, medical, finance and encryption/decryption computations. The high parallelism offered by the hardware of the parallel data processing unit 530 and used for simultaneously rendering multiple pixels, is capable of also simultaneously processing the multiple data elements of the scientific, medical, finance, encryption/decryption and other computations.

Function calls within applications are translated to commands by a given application programming interface (API). The processing unit 510 sends the translated commands to the memory 520 for storage in the ring buffer 522. The commands are placed in groups referred to as command groups. In some implementations, the processing units 510 and 530 use a producer-consumer relationship, which is also be referred to as a client-server relationship. The processing unit 510 writes commands into the ring buffer 522. Then the parallel data processing unit 530 reads the commands from the ring buffer 522, processes the commands, and writes result data to the buffer 524. The processing unit 510 is configured to update a write pointer for the ring buffer 522 and provide a size for each command group. The parallel data processing unit 530 updates a read pointer for the ring buffer 522 and indicates the entry in the ring buffer 522 at which the next read operation will use.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high level programming language such as C, or a design language (HDL) such as Verilog, VHDL, or database format such as GDS II stream format (GDSII). In some cases the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVE®, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
a plurality of partitions, each comprising a plurality of replicated computational units;
a power manager configured to:
assign a first set of operating parameters to a first partition of the plurality of partitions, based at least in part on a number of replicated computational units in the first partition that are operational; and
assign a second set of operating parameters to a second partition of the plurality of partitions, based at least in part on a number of replicated computational units in the second partition that are operational.

2. The apparatus as recited in claim 1, wherein the first partition and the second partition are configured to process tasks of a workload using the first set of operating parameters and the second set of operating parameters, respectively.

3. The apparatus as recited in claim 2, wherein based on the first set of operating parameters and the second set of operating parameters, a difference between a throughput of the first partition and a throughput of the second partition is less than a threshold.

4. The apparatus as recited in claim 2, wherein each of the plurality of partitions is configured to process the workload using a parallel data microarchitecture.

5. The apparatus as recited in claim 2, wherein in response to determining a condition has been satisfied for updating operating parameters of the plurality of partitions, the power manager is further configured to assign updated values for the first set of operating parameters and the second set of operating parameters.

6. The apparatus as recited in claim 5, wherein the updated values for the first set of operating parameters and the second set of operating parameters are based at least in part on the power manager receiving a plurality of performance metrics monitored during processing of the workload.

7. The apparatus as recited in claim 5, wherein the condition for updating power domains comprises one or more of:
determining, by the power manager, a time interval has elapsed; and
determining, by the power manager, that a throughput of the plurality of partitions has changed by more than a threshold amount.

8. A method, comprising:
processing tasks by a plurality of partitions, each comprising a plurality of replicated computational units;
assigning, by a power manager, a first set of operating parameters to a first partition of the plurality of partitions, based at least in part on a number of replicated computational units in the first partition that are operational; and
assigning, by the power manager, a second set of operating parameters to a second partition of the plurality of partitions, based at least in part on a number of replicated computational units in the second partition that are operational.

9. The method as recited in claim 8, further comprising processing tasks of a workload by the first partition and the second partition using the first set of operating parameters and the second set of operating parameters, respectively.

10. The method as recited in claim 9, wherein based on the first set of operating parameters and the second set of operating parameters, a difference between a throughput of the first partition and a throughput of the second partition is less than a threshold.

11. The method as recited in claim 9, further comprising processing the workload by each of the plurality of partitions using a parallel data microarchitecture.

12. The method as recited in claim 9, wherein in response to determining a condition has been satisfied for updating operating parameters of the plurality of partitions, the method further comprises assigning, by the power manager, updated values for the first set of operating parameters and the second set of operating parameters.

13. The method as recited in claim 12, wherein the updated values for the first set of operating parameters and the second set of operating parameters are based at least in part on the power manager receiving a plurality of performance metrics monitored during processing of the workload.

14. The method as recited in claim 12, wherein the condition for updating power domains comprises one or more of:
determining, by the power manager, a time interval has elapsed; and
determining, by the power manager, that a throughput of the plurality of partitions has changed by more than a threshold amount.

15. A computing system comprising:
a memory configured to store one or more applications of a workload; and
a processing unit comprising:
a plurality of partitions, each comprising a plurality of replicated computational units;
a power manager configured to:
assign a first set of operating parameters to a first partition of the plurality of partitions, based at least in part on a number of replicated computational units in the first partition that are operational; and
assign a second set of operating parameters to a second partition of the plurality of partitions, based at least in part on a number of replicated computational units in the second partition that are operational.

16. The computing system as recited in claim 15, wherein the first partition and the second partition are configured to process tasks of a workload using the first set of operating parameters and the second set of operating parameters, respectively.

17. The computing system as recited in claim 16, wherein based on the first set of operating parameters and the second set of operating parameters, a difference between a throughput of the first partition and a throughput of the second partition is less than a threshold.

18. The computing system as recited in claim 16, wherein each of the plurality of partitions is configured to process the workload using a parallel data microarchitecture.

19. The computing system as recited in claim 16, wherein in response to determining a condition has been satisfied for updating operating parameters of the plurality of partitions, the power manager is further configured to assign updated values for the first set of operating parameters and the second set of operating parameters.

20. The computing system as recited in claim 19, wherein the updated values for the first set of operating parameters and the second set of operating parameters are based at least in part on the power manager receiving a plurality of performance metrics monitored during processing of the workload.
